(19) United States
(12) Patent Application Publication
(10) Pub. No.: US 2019/0114546 A1
(43) Pub. Date: Apr. 18, 2019

(54) REFINING LABELING OF TIME-ASSOCIATED DATA

(71) Applicant: NVIDIA Corporation, Santa Clara, CA (US)

(72) Inventors: Cem Anil, Toronto (CA); Gavriel Robert State, Toronto (CA)

(21) Appl. No.: 16/153,430

(22) Filed: Oct. 5, 2018

Related U.S. Application Data
(60) Provisional application No. 62/571,711, filed on Oct. 12, 2017.

(51) Int. Cl. G06N 3/08; G06N 3/04

(52) U.S. Cl. CPC G06N 3/084; G06N 3/04

(57) ABSTRACT

A method, computer readable medium, and system are disclosed for identifying predicted labels for a plurality of time-associated data points. The time-associated data points may include data points ordered according to time, where each data point is associated with an individual time value. A convolutional neural network (CNN) is also trained, utilizing the predicted labels for the plurality of time-associated data points as well as ground truth labels for the plurality of time-associated data points, in order to create a trained CNN. The ground truth labels may include labels for the time-associated data points that have been verified as correct. Error correction is then performed, utilizing the trained CNN. For example, the trained CNN may create and return error-corrected labels for another plurality of time-associated data points, based on the predicted labels for the other plurality of time-associated data points, which may increase an accuracy of the labels.

### CLAIM OF PRIORITY

This application claims the benefit of U.S. Provisional Application No. 62/571,711 (Attorney Docket No. NVIDP1191+/17-TR-0219-US01) titled “A Deep Learning Based Approach for Time Series Data Post-Processing,” filed Oct. 12, 2017, the entire contents of which is incorporated herein by reference.

### FIELD OF THE INVENTION

The present invention relates to labeling training data, and more particularly to creating and refining labeled data for training deep learning implementations including time series applications.

### BACKGROUND

Labeled data is integral to the training of deep learning-based solutions. However, current means for producing this labeled data are time-consuming, resource-intensive, and complicated. For example, producing consistent and accurately-labeled results for large amounts of data currently requires large, complex time series regression models that take a significant amount of time and resources to train. It is desirable to create a simplified means for producing high-quality labeled data. There is therefore a need for addressing these issues and/or other issues associated with the prior art.

### BRIEF DESCRIPTION OF THE DRAWINGS

FIG. 1 illustrates a flowchart of a method for post-processing time series data, in accordance with an embodiment.

FIG. 2 illustrates a parallel processing unit, in accordance with an embodiment.

FIG. 3A illustrates a general processing cluster within the parallel processing unit of FIG. 2, in accordance with an embodiment.

FIG. 3B illustrates a memory partition unit of the parallel processing unit of FIG. 2, in accordance with an embodiment.

FIG. 4A illustrates the streaming multi-processor of FIG. 3A, in accordance with an embodiment.

FIG. 4B is a conceptual diagram of a processing system implemented using the PPU of FIG. 2, in accordance with an embodiment.

FIG. 4C illustrates an exemplary system in which the various architecture and/or functionality of the various previous embodiments may be implemented.

FIG. 5 is a conceptual diagram of a graphics processing pipeline implemented by the PPU of FIG. 2, in accordance with an embodiment.

### DETAILED DESCRIPTION

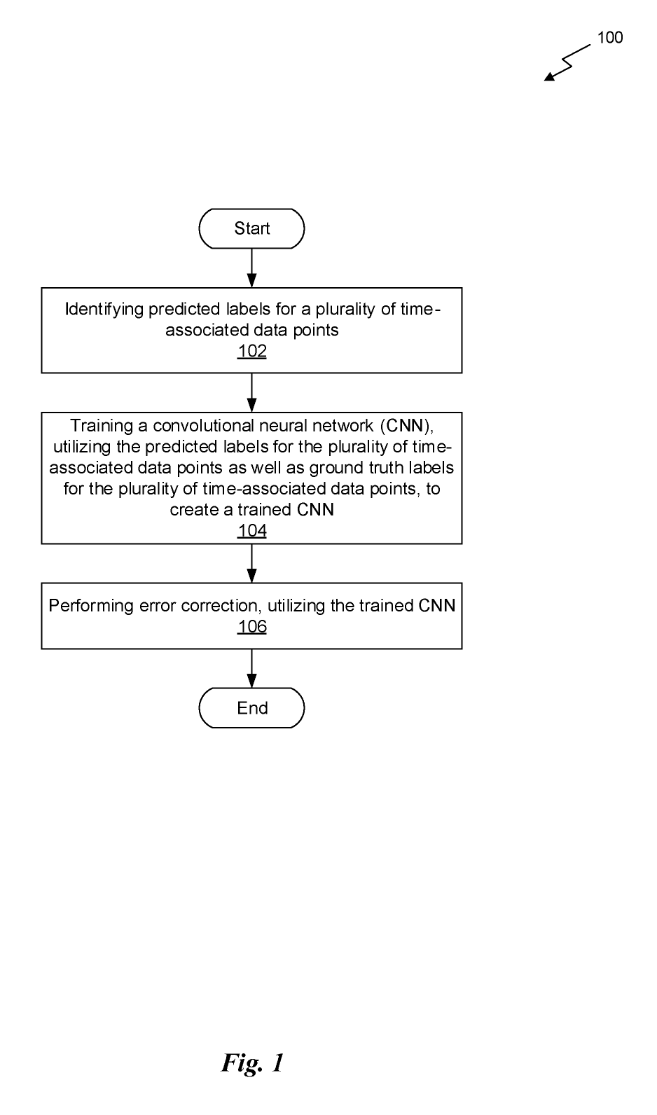

FIG. 1 illustrates a flowchart of a method 100 for post-processing time series data, in accordance with an embodiment. Although method 100 is described in the context of a processing unit, the method 100 may also be performed by a program, custom circuitry, or by a combination of custom circuitry and a program. For example, the method 100 may be executed by a GPU (graphics processing unit), CPU (central processing unit), or any processor capable of performing parallel path space filtering by hashing. Furthermore, persons of ordinary skill in the art will understand that any system that performs method 100 is within the scope and spirit of embodiments of the present invention.

As shown in operation 102, predicted labels are identified for a plurality of time-associated data points. In one embodiment, the predicted labels may be created utilizing any time-series regression model. In one embodiment, the time-series regression may include a method for creating labels associated with a stream of time-associated data.

In one embodiment, time-series regression may identify and analyze time-associated data points, and create labels for each of the time-associated data points, based on the analysis. In one embodiment, the time-associated data points may include data points ordered according to time, where each data point (e.g., instance of data, etc.) is associated with an individual time value. Examples of time-associated data may include video data (e.g., a plurality of video frames), motion capture (mocap) data, time-based event data, time-based location data, time-based sensor data, etc. Examples of labels for the time-associated data points may include phase values corresponding to human motion capture data, estimated speed (e.g., automobile speed, etc.), etc.

Additionally, in one embodiment, the time-series regression may be performed utilizing one or more models. In one embodiment, the time-series regression may be performed utilizing one or more of linear regression, a feed-forward neural network, a convolutional neural network (CNN), a long short-term memory (LSTM) network, a recurrent neural network (RNN), etc. In one embodiment, each of the plurality of time-associated data points may have an associated predicted label. In one embodiment, the plurality of time-associated data points may be identified along with the predicted labels for the plurality of time-associated data points.

Further, in one embodiment, the plurality of time-associated data points may include frames of video recorded by a camera coupled to an automobile. In one embodiment, the predicted labels may include a speed of the automobile during the frame of video. In one embodiment, the plurality of time-associated data points may include mocap data. In one embodiment, the predicted labels may include a phase value for each instance of the mocap data. In one embodiment, the plurality of time-associated data points may include video data. In one embodiment, the predicted labels may include a location of one or more objects within each frame of the video data.

Further still, as shown in operation 104, a convolutional neural network (CNN) is trained, utilizing the predicted labels for the plurality of time-associated data points as well as ground truth labels for the plurality of time-associated data points, to create a trained CNN. In one embodiment, the time-associated data points may also be used to train the CNN. In one embodiment, the plurality of time-associated data points, the predicted labels for the plurality of time-associated data points, and the ground truth labels for the plurality of time-associated data points may all be used to train the CNN.

Also, in one embodiment, the ground truth labels may include labels for the time-associated data points that have been verified as correct (e.g., by one or more users, etc.). In one embodiment, each of the plurality of time-associated data points may have an associated ground truth label. In one embodiment, both the time-associated data points and the ground truth labels for the plurality of time-associated data points may be input into the CNN.

In addition, in one embodiment, the CNN may include a one-dimensional (1D) convolutional neural network. In one embodiment, the untrained CNN may be trained to map the predicted labels for the plurality of time-associated data points to the ground truth labels for the plurality of time-associated data points. In this way, the untrained CNN may be trained to provide error-corrected labels for the plurality of time-associated data points in response to the input of predicted labels for the plurality of time-associated data points. The untrained CNN may also be trained to learn and correct structured errors in time series predictions made by time-series regression models.

Furthermore, as shown in operation 106, error correction is performed, utilizing the trained CNN. In one embodiment, performing the error correction may include inputting another plurality of time-associated data points, and predicted labels for the other plurality of time-associated data points, into the trained CNN.

Further still, in one embodiment, the predicted labels for the plurality of time-associated data points input into the trained CNN may be different from the predicted labels for the plurality of time-associated data points used to train the CNN. In one embodiment, the plurality of time-associated data points input into the trained CNN may be different from the plurality of time-associated data points used to train the CNN.

In one embodiment, a first set of predicted labels for a first plurality of time-associated data points may be used to train the CNN, along with ground truth labels for the first plurality of time-associated data points. In one embodiment, a second set of predicted labels for a second plurality of time-associated data points may then be input into the trained CNN, where the second set of predicted labels is different from the first set of predicted labels, and the second plurality of time-associated data points are different from the first plurality of time-associated data points.

Also, in one embodiment, the second plurality of time-associated data points may include raw data that does not have ground truth labels. In one embodiment, the second plurality of time-associated data points may be created utilizing time-series regression. In one embodiment, the method of time-series regression used to create the predicted labels for the second plurality of time-associated data points may be the same as, or different from, the method of time-series regression used to create the predicted labels for the first plurality of time-associated data points.

Additionally, in one embodiment, performing the error correction may include creating and returning error-corrected labels for the other plurality of time-associated data points, based on the predicted labels for the other plurality of time-associated data points, utilizing the trained CNN. In one embodiment, the trained CNN may take the predicted labels for the other plurality of time-associated data points and may update the predicted labels to be as close to a ground truth as possible.

In this way, the trained CNN may post-process labeled results of time-series regression to refine/dynamically correct the labeled results. More generally, the trained CNN may dynamically correct systematic errors made during the time-series regression, and may produce a more refined set of labels for time-associated data points.

Further, in one embodiment, the other plurality of time-associated data points, and the error-corrected labels for the other plurality of time-associated data points, may then be used to train another neural network. In one embodiment, instead of creating a complex time-series regression model (e.g., for use in large data sets, etc.) that is difficult to train, a trained CNN may perform error correction on a simpler time-series regression model, and may improve an overall accuracy of the time-series regression model. This may simplify an implementation and a training of the initial time-series regression model used to create the predicted labels.

In one embodiment, time-series regression may be used to label mocap data with predicted phase values. In one embodiment, a phase value may indicate a predetermined phase of a motion cycle (e.g., a human walk cycle, climb cycle, jump cycle, etc.). In another example, the time-series regression may analyze a first plurality of instances of mocap data and assign a predicted phase value to each instance of the mocap data. In one embodiment, the first plurality of instances of mocap data, the predicted phase values for each instance of mocap data, and ground truth phase values for each instance of mocap data may be used to train a CNN to create a trained CNN.

In one embodiment, afterwards, a second plurality of instances of mocap data (different from the first plurality of instances of mocap data), and predicted phase values for each of the second plurality of instances of the mocap data (different from the predicted phase values for the first plurality of instances of mocap data) may be input into the trained CNN. In one embodiment, the trained CNN may then create and return error-corrected phase values for the second plurality of instances of the mocap data.

In one embodiment, the second plurality of instances of mocap data and the error-corrected phase values for the second plurality of instances of the mocap data may then be used to train a deep learning model (e.g., a neural network, etc.) to imitate motion (e.g., human motion, etc.).

In this way, a CNN may be trained to learn and correct structured errors in time series predictions. Additionally, the trained CNN may be used to post-process labeled results of time-series regression to refine/dynamically correct the labeled results.

More illustrative information will now be set forth regarding various optional architectures and features with which the foregoing framework may be implemented, per the desires of the user. It should be strongly noted that the following information is set forth for illustrative purposes and should not be construed as limiting in any manner. Any of the following features may be optionally incorporated with or without the exclusion of other features described.

### Parallel Processing Architecture

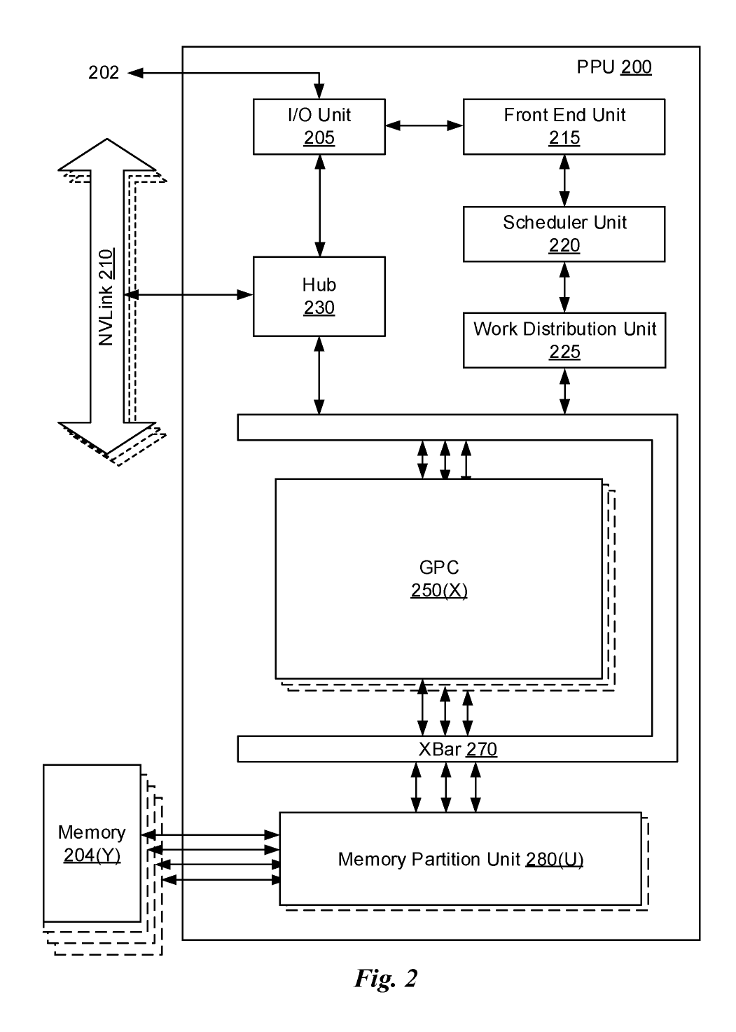

FIG. 2 illustrates a parallel processing unit (PPU) 200, in accordance with an embodiment. In an embodiment, the PPU 200 is a multi-threaded processor that is implemented on one or more integrated circuit devices. The PPU 200 is a latency hiding architecture designed to process many threads in parallel. A thread (i.e., a thread of execution) is an instantiation of a set of instructions configured to be executed by the PPU 200. In an embodiment, the PPU 200 is a graphics processing unit (GPU) configured to implement a graphics rendering pipeline for processing three-dimensional (3D) graphics data in order to generate two-dimensional (2D) image data for display on a display device such as a liquid crystal display (LCD) device. In other embodiments, the PPU 200 may be utilized for performing general-purpose computations. While one exemplary parallel processor is provided herein for illustrative purposes, it should be strongly noted that such processor is set forth for illustrative purposes only, and that any processor may be employed to supplement and/or substitute for the same.

One or more PPUs 200 may be configured to accelerate thousands of High Performance Computing (HPC), data center, and machine learning applications. The PPU 200 may be configured to accelerate numerous deep learning systems and applications including autonomous vehicle platforms, deep learning, high-accuracy speech, image, and text recognition systems, intelligent video analytics, molecular simulations, drug discovery, disease diagnosis, weather forecasting, big data analytics, astronomy, molecular dynamics simulation, financial modeling, robotics, factory automation, real-time language translation, online search optimizations, and personalized user recommendations, and the like.

As shown in FIG. 2, the PPU 200 includes an Input/Output (I/O) unit 205, a front end unit 215, a scheduler unit 220, a work distribution unit 225, a hub 230, a crossbar (Xbar) 270, one or more general processing clusters (GPCs) 250, and one or more partition units 280. The PPU 200 may be connected to a host processor or other PPUs 200 via one or more high-speed NVLink 210 interconnect. The PPU 200 may be connected to a host processor or other peripheral devices via an interconnect 202. The PPU 200 may also be connected to a local memory comprising a number of memory devices 204. In an embodiment, the local memory may comprise a number of dynamic random access memory (DRAM) devices. The DRAM devices may be configured as a high-bandwidth memory (HBM) subsystem, with multiple DRAM dies stacked within each device.

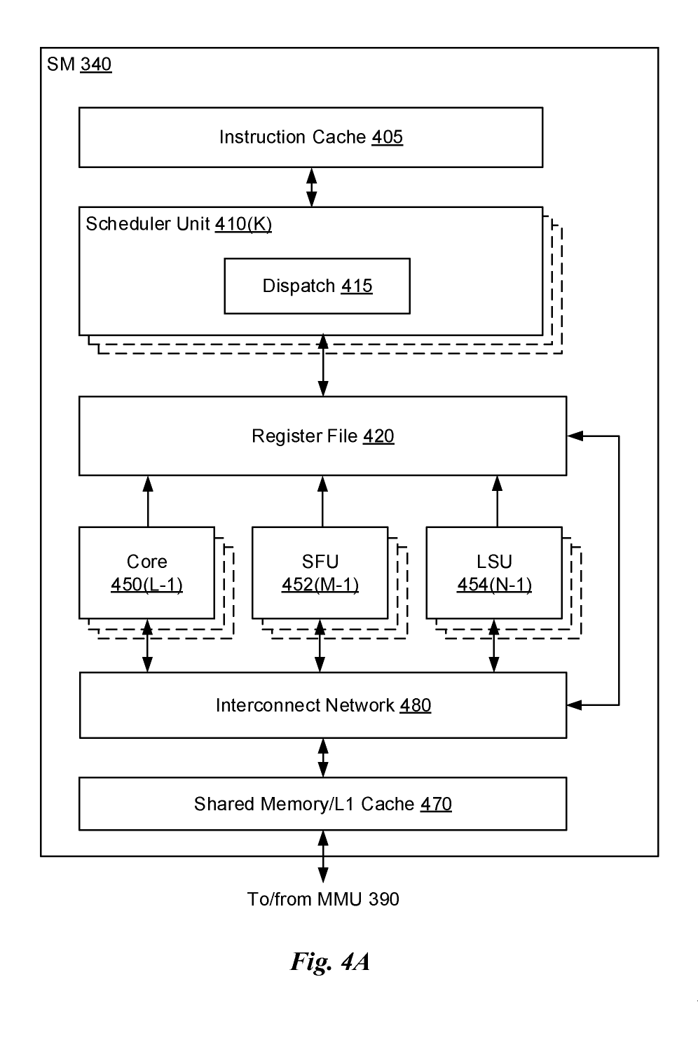

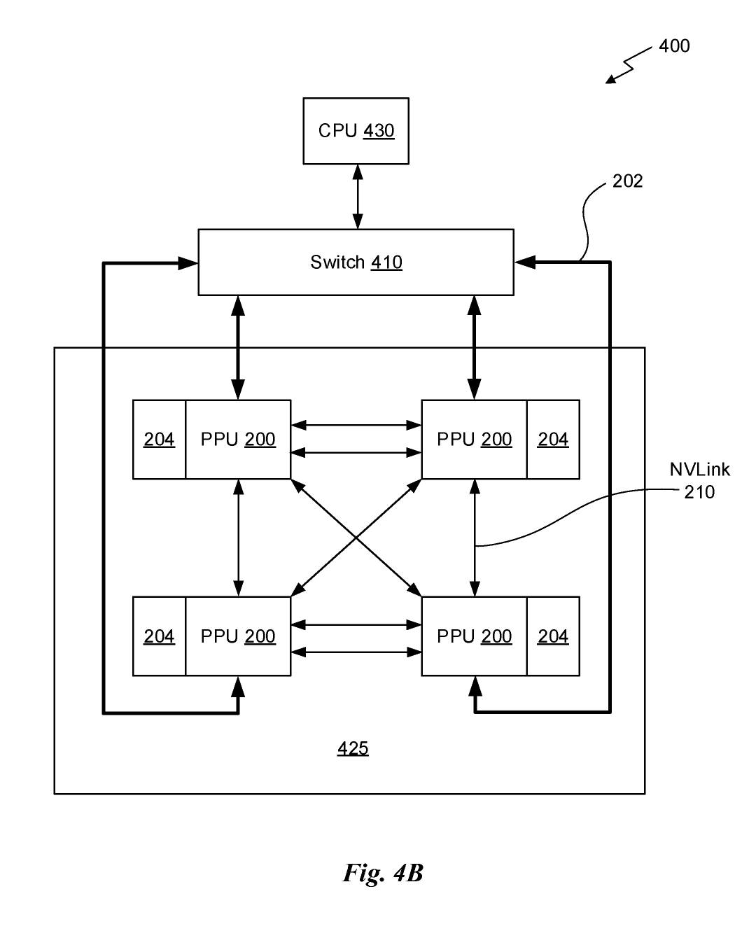

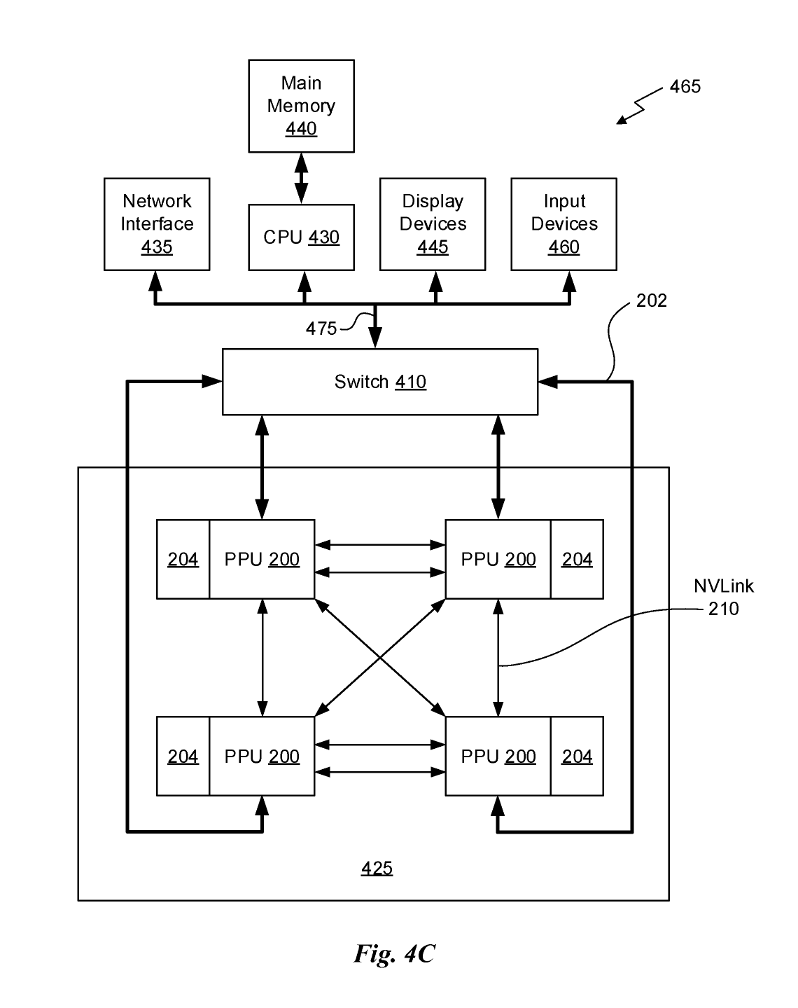

The NVLink 210 interconnect enables systems to scale and include one or more PPUs 200 combined with one or more CPUs, supports cache coherence between the PPUs 200 and CPUs, and CPU mastering. Data and/or commands may be transmitted by the NVLink 210 through the hub 230 to/from other units of the PPU 200 such as one or more copy engines, a video encoder, a video decoder, a power management unit, etc. (not explicitly shown). The NVLink 210 is described in more detail in conjunction with FIG. 4B.

The I/O unit 205 is configured to transmit and receive communications (i.e., commands, data, etc.) from a host processor (not shown) over the interconnect 202. The I/O unit 205 may communicate with the host processor directly via the interconnect 202 or through one or more intermediate devices such as a memory bridge. In an embodiment, the I/O unit 205 may communicate with one or more other processors, such as one or more the PPUs 200 via the interconnect 202. In an embodiment, the I/O unit 205 implements a Peripheral Component Interconnect Express (PCIe) interface for communications over a PCIe bus and the interconnect 202 is a PCIe bus. In alternative embodiments, the I/O unit 205 may implement other types of well-known interfaces for communicating with external devices.

The I/O unit 205 decodes packets received via the interconnect 202. In an embodiment, the packets represent commands configured to cause the PPU 200 to perform various operations. The I/O unit 205 transmits the decoded commands to various other units of the PPU 200 as the commands may specify. For example, some commands may be transmitted to the front end unit 215. Other commands may be transmitted to the hub 230 or other units of the PPU 200 such as one or more copy engines, a video encoder, a video decoder, a power management unit, etc. (not explicitly shown). In other words, the I/O unit 205 is configured to route communications between and among the various logical units of the PPU 200.

In an embodiment, a program executed by the host processor encodes a command stream in a buffer that provides workloads to the PPU 200 for processing. A workload may comprise several instructions and data to be processed by those instructions. The buffer is a region in a memory that is accessible (i.e., read/write) by both the host processor and the PPU 200. For example, the I/O unit 205 may be configured to access the buffer in a system memory connected to the interconnect 202 via memory requests transmitted over the interconnect 202. In an embodiment, the host processor writes the command stream to the buffer and then transmits a pointer to the start of the command stream to the PPU 200. The front end unit 215 receives pointers to one or more command streams. The front end unit 215 manages the one or more streams, reading commands from the streams and forwarding commands to the various units of the PPU 200.

The front end unit 215 is coupled to a scheduler unit 220 that configures the various GPCs 250 to process tasks defined by the one or more streams. The scheduler unit 220 is configured to track state information related to the various tasks managed by the scheduler unit 220. The state may indicate which GPC 250 a task is assigned to, whether the task is active or inactive, a priority level associated with the task, and so forth. The scheduler unit 220 manages the execution of a plurality of tasks on the one or more GPCs 250.

The scheduler unit 220 is coupled to a work distribution unit 225 that is configured to dispatch tasks for execution on the GPCs 250. The work distribution unit 225 may track a number of scheduled tasks received from the scheduler unit 220. In an embodiment, the work distribution unit 225 manages a pending task pool and an active task pool for each of the GPCs 250. The pending task pool may comprise a number of slots (e.g., 32 slots) that contain tasks assigned to be processed by a particular GPC 250. The active task pool may comprise a number of slots (e.g., 4 slots) for tasks that are actively being processed by the GPCs 250. As a GPC 250 finishes the execution of a task, that task is evicted from the active task pool for the GPC 250 and one of the other tasks from the pending task pool is selected and scheduled for execution on the GPC 250. If an active task has been idle on the GPC 250, such as while waiting for a data dependency to be resolved, then the active task may be evicted from the GPC 250 and returned to the pending task pool while another task in the pending task pool is selected and scheduled for execution on the GPC 250.

The work distribution unit 225 communicates with the one or more GPCs 250 via XBar 270. The XBar 270 is an interconnect network that couples many of the units of the PPU 200 to other units of the PPU 200. For example, the XBar 270 may be configured to couple the work distribution unit 225 to a particular GPC 250. Although not shown explicitly, one or more other units of the PPU 200 may also be connected to the XBar 270 via the hub 230.

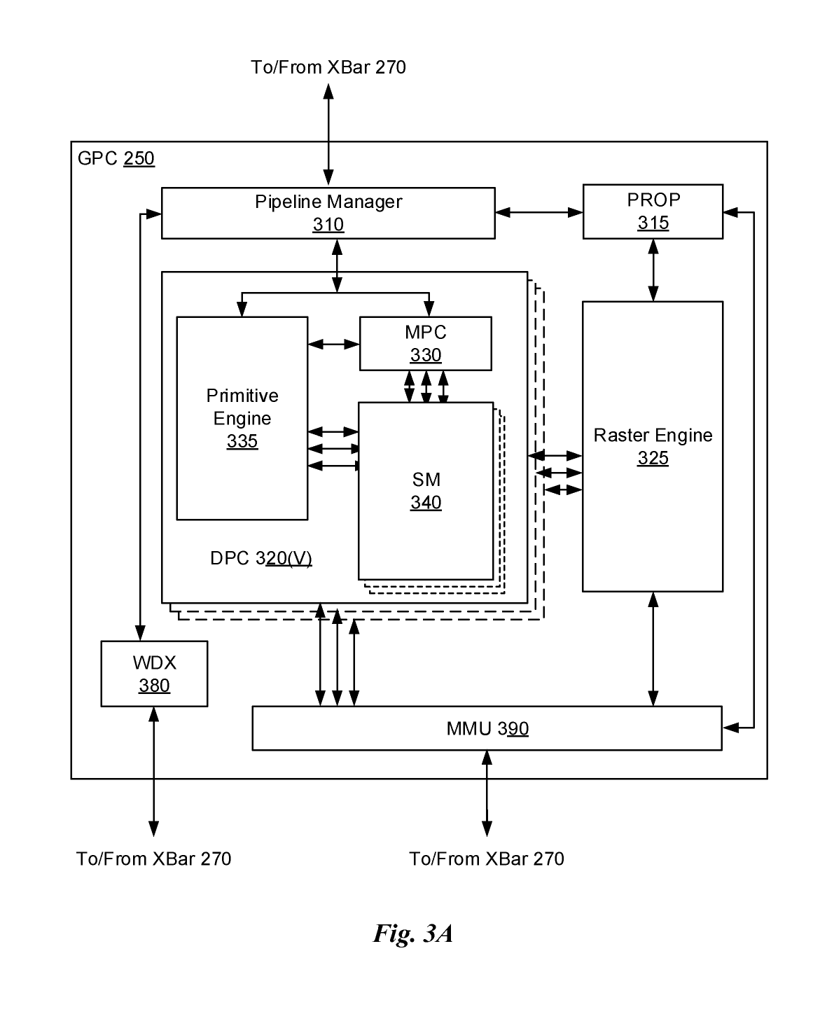

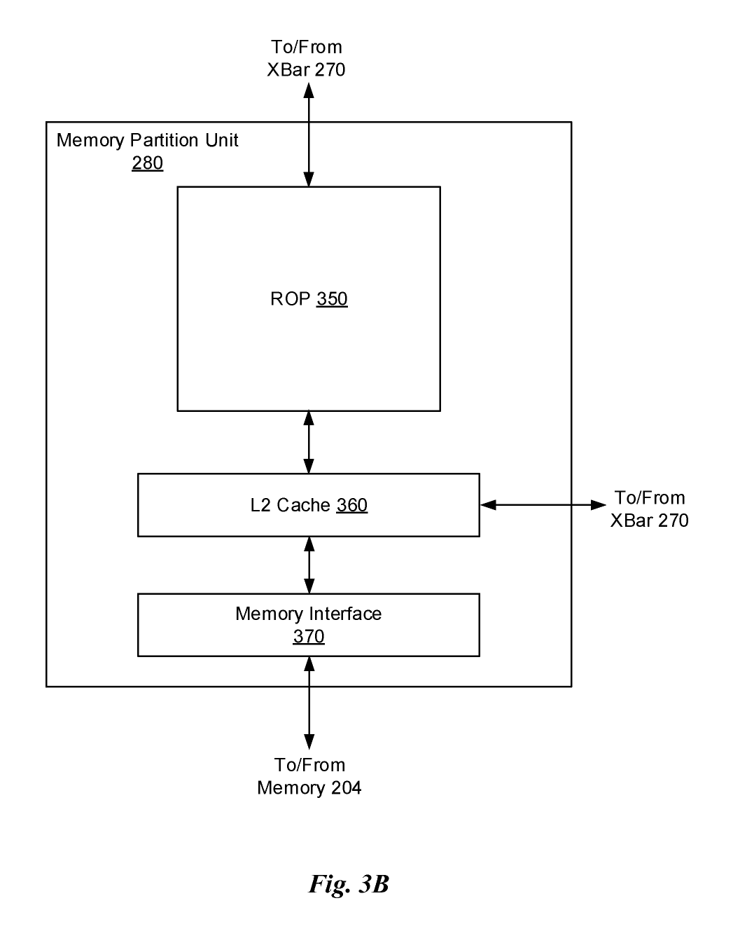

The tasks are managed by the scheduler unit 220 and dispatched to a GPC 250 by the work distribution unit 225. The GPC 250 is configured to process the task and generate results. The results may be consumed by other tasks within the GPC 250, routed to a different GPC 250 via the XBar 270, or stored in the memory 204. The results can be written to the memory 204 via the partition units 280, which implement a memory interface for reading and writing data to/from the memory 204. The results can be transmitted to another PPU 200 or CPU via the NVLink 210. In an embodiment, the PPU 200 includes a number U of partition units 280 that is equal to the number of separate and distinct memory devices 204 coupled to the PPU 200. A partition unit 280 will be described in more detail below in conjunction with FIG. 3B.

In an embodiment, a host processor executes a driver kernel that implements an application programming interface (API) that enables one or more applications executing on the host processor to schedule operations for execution on the PPU 200. In an embodiment, multiple compute applications are simultaneously executed by the PPU 200 and the PPU 200 provides isolation, quality of service (QoS), and independent address spaces for the multiple compute applications. An application may generate instructions (i.e., API calls) that cause the driver kernel to generate one or more tasks for execution by the PPU 200. The driver kernel outputs tasks to one or more streams being processed by the PPU 200. Each task may comprise one or more groups of related threads, referred to herein as a warp. In an embodiment, a warp comprises 32 related threads that may be executed in parallel. Cooperating threads may refer to a plurality of threads including instructions to perform the task and that may exchange data through shared memory. Threads and cooperating threads are described in more detail in conjunction with FIG. 4A.

FIG. 3A illustrates a GPC 250 of the PPU 200 of FIG. 2, in accordance with an embodiment. As shown in FIG. 3A, each GPC 250 includes a number of hardware units for processing tasks. In an embodiment, each GPC 250 includes a pipeline manager 310, a pre-raster operations unit (PROP) 315, a raster engine 325, a work distribution crossbar (WDX) 380, a memory management unit (MMU) 390, and one or more Data Processing Clusters (DPCs) 320. It will be appreciated that the GPC 250 of FIG. 3A may include other hardware units in lieu of or in addition to the units shown in FIG. 3A.

In an embodiment, the operation of the GPC 250 is controlled by the pipeline manager 310. The pipeline manager 310 manages the configuration of the one or more DPCs 320 for processing tasks allocated to the GPC 250. In an embodiment, the pipeline manager 310 may configure at least one of the one or more DPCs 320 to implement at least a portion of a graphics rendering pipeline. For example, a DPC 320 may be configured to execute a vertex shader program on the programmable streaming multiprocessor (SM) 340. The pipeline manager 310 may also be configured to route packets received from the work distribution unit 225 to the appropriate logical units within the GPC 250. For example, some packets may be routed to fixed function hardware units in the PROP 315 and/or raster engine 325 while other packets may be routed to the DPCs 320 for processing by the primitive engine 335 or the SM 340. In an embodiment, the pipeline manager 310 may configure at least one of the one or more DPCs 320 to implement a neural network model and/or a computing pipeline.

The PROP unit 315 is configured to route data generated by the raster engine 325 and the DPCs 320 to a Raster Operations (ROP) unit, described in more detail in conjunction with FIG. 3B. The PROP unit 315 may also be configured to perform optimizations for color blending, organize pixel data, perform address translations, and the like.

The raster engine 325 includes a number of fixed function hardware units configured to perform various raster operations. In an embodiment, the raster engine 325 includes a setup engine, a coarse raster engine, a culling engine, a clipping engine, a fine raster engine, and a tile coalescing engine. The setup engine receives transformed vertices and generates plane equations associated with the geometric primitive defined by the vertices. The plane equations are transmitted to the coarse raster engine to generate coverage information (e.g., an x,y coverage mask for a tile) for the primitive. The output of the coarse raster engine is transmitted to the culling engine where fragments associated with the primitive that fail a z-test are culled, and transmitted to a clipping engine where fragments lying outside a viewing frustum are clipped. Those fragments that survive clipping and culling may be passed to the fine raster engine to generate attributes for the pixel fragments based on the plane equations generated by the setup engine. The output of the raster engine 325 comprises fragments to be processed, for example, by a fragment shader implemented within a DPC 320.

Each DPC 320 included in the GPC 250 includes an M-Pipe Controller (MPC) 330, a primitive engine 335, and one or more SMs 340. The MPC 330 controls the operation of the DPC 320, routing packets received from the pipeline manager 310 to the appropriate units in the DPC 320. For example, packets associated with a vertex may be routed to the primitive engine 335, which is configured to fetch vertex attributes associated with the vertex from the memory 204. In contrast, packets associated with a shader program may be transmitted to the SM 340.

The SM 340 comprises a programmable streaming processor that is configured to process tasks represented by a number of threads. Each SM 340 is multi-threaded and configured to execute a plurality of threads (e.g., 32 threads) from a particular group of threads concurrently. In an embodiment, the SM 340 implements a SIMD (Single-Instruction, Multiple-Data) architecture where each thread in a group of threads (i.e., a warp) is configured to process a different set of data based on the same set of instructions. All threads in the group of threads execute the same instructions. In another embodiment, the SM 340 implements a SIMT (Single-Instruction, Multiple Thread) architecture where each thread in a group of threads is configured to process a different set of data based on the same set of instructions, but where individual threads in the group of threads are allowed to diverge during execution. In an embodiment, a program counter, call stack, and execution state is maintained for each warp, enabling concurrency between warps and serial execution within warps when threads within the warp diverge. In another embodiment, a program counter, call stack, and execution state is maintained for each individual thread, enabling equal concurrency between all threads, within and between warps. When execution state is maintained for each individual thread, threads executing the same instructions may be converged and executed in parallel for maximum efficiency. The SM 340 will be described in more detail below in conjunction with FIG. 4A.

The MMU 390 provides an interface between the GPC 250 and the partition unit 280. The MMU 390 may provide translation of virtual addresses into physical addresses, memory protection, and arbitration of memory requests. In an embodiment, the MMU 390 provides one or more translation lookaside buffers (TLBs) for performing translation of virtual addresses into physical addresses in the memory 204.

FIG. 3B illustrates a memory partition unit 280 of the PPU 200 of FIG. 2, in accordance with an embodiment. As shown in FIG. 3B, the memory partition unit 280 includes a Raster Operations (ROP) unit 350, a level two (L2) cache 360, and a memory interface 370. The memory interface 370 is coupled to the memory 204. Memory interface 370 may implement 32, 64, 128, 1024-bit data buses, or the like, for high-speed data transfer. In an embodiment, the PPU 200 incorporates U memory interfaces 370, one memory interface 370 per pair of partition units 280, where each pair of partition units 280 is connected to a corresponding memory device 204. For example, PPU 200 may be connected to up to Y memory devices 204, such as high bandwidth memory stacks or graphics double-data-rate, version 5, synchronous dynamic random access memory, or other types of persistent storage.

In an embodiment, the memory interface 370 implements an HBM2 memory interface and Y equals half U. In an embodiment, the HBM2 memory stacks are located on the same physical package as the PPU 200, providing substantial power and area savings compared with conventional GDDR5 SDRAM systems. In an embodiment, each HBM2 stack includes four memory dies and Y equals 4, with HBM2 stack including two 128-bit channels per die for a total of 8 channels and a data bus width of 1024 bits.

In an embodiment, the memory 204 supports Single-Error Correcting Double-Error Detecting (SECDED) Error Correction Code (ECC) to protect data. ECC provides higher reliability for compute applications that are sensitive to data corruption. Reliability is especially important in large-scale cluster computing environments where PPUs 200 process very large datasets and/or run applications for extended periods.

In an embodiment, the PPU 200 implements a multi-level memory hierarchy. In an embodiment, the memory partition unit 280 supports a unified memory to provide a single unified virtual address space for CPU and PPU 200 memory, enabling data sharing between virtual memory systems. In an embodiment the frequency of accesses by a PPU 200 to memory located on other processors is traced to ensure that memory pages are moved to the physical memory of the PPU 200 that is accessing the pages more frequently. In an embodiment, the NVLink 210 supports address translation services allowing the PPU 200 to directly access a CPU's page tables and providing full access to CPU memory by the PPU 200.

In an embodiment, copy engines transfer data between multiple PPUs 200 or between PPUs 200 and CPUs. The copy engines can generate page faults for addresses that are not mapped into the page tables. The memory partition unit 280 can then service the page faults, mapping the addresses into the page table, after which the copy engine can perform the transfer. In a conventional system, memory is pinned (i.e., non-pageable) for multiple copy engine operations between multiple processors, substantially reducing the available memory. With hardware page faulting, addresses can be passed to the copy engines without worrying if the memory pages are resident, and the copy process is transparent.

Data from the memory 204 or other system memory may be fetched by the memory partition unit 280 and stored in the L2 cache 360, which is located on-chip and is shared between the various GPCs 250. As shown, each memory partition unit 280 includes a portion of the L2 cache 360 associated with a corresponding memory device 204. Lower level caches may then be implemented in various units within the GPCs 250. For example, each of the SMs 340 may implement a level one (L1) cache. The L1 cache is private memory that is dedicated to a particular SM 340. Data from the L2 cache 360 may be fetched and stored in each of the L1 caches for processing in the functional units of the SMs 340. The L2 cache 360 is coupled to the memory interface 370 and the XBar 270.

The ROP unit 350 performs graphics raster operations related to pixel color, such as color compression, pixel blending, and the like. The ROP unit 350 also implements depth testing in conjunction with the raster engine 325, receiving a depth for a sample location associated with a pixel fragment from the culling engine of the raster engine 325. The depth is tested against a corresponding depth in a depth buffer for a sample location associated with the fragment. If the fragment passes the depth test for the sample location, then the ROP unit 350 updates the depth buffer and transmits a result of the depth test to the raster engine 325. It will be appreciated that the number of partition units 280 may be different than the number of GPCs 250 and, therefore, each ROP unit 350 may be coupled to each of the GPCs 250. The ROP unit 350 tracks packets received from the different GPCs 250 and determines which GPC 250 that a result generated by the ROP unit 350 is routed to through the Xbar 270. Although the ROP unit 350 is included within the memory partition unit 280 in FIG. 3B, in other embodiment, the ROP unit 350 may be outside of the memory partition unit 280. For example, the ROP unit 350 may reside in the GPC 250 or another unit.

FIG. 4A illustrates the streaming multi-processor 340 of FIG. 3A, in accordance with an embodiment. As shown in FIG. 4A, the SM 340 includes an instruction cache 405, one or more scheduler units 410(K), a register file 420, one or more processing cores 450, one or more special function units (SFUs) 452, one or more load/store units (LSUs) 454, an interconnect network 480, a shared memory/L1 cache 470.

As described above, the work distribution unit 225 dispatches tasks for execution on the GPCs 250 of the PPU 200. The tasks are allocated to a particular DPC 320 within a GPC 250 and, if the task is associated with a shader program, the task may be allocated to an SM 340. The scheduler unit 410(K) receives the tasks from the work distribution unit 225 and manages instruction scheduling for one or more thread blocks assigned to the SM 340. The scheduler unit 410(K) schedules thread blocks for execution as warps of parallel threads, where each thread block is allocated at least one warp. In an embodiment, each warp executes 32 threads. The scheduler unit 410(K) may manage a plurality of different thread blocks, allocating the warps to the different thread blocks and then dispatching instructions from the plurality of different cooperative groups to the various functional units (i.e., cores 450, SFUs 452, and LSUs 454) during each clock cycle.

Cooperative Groups is a programming model for organizing groups of communicating threads that allows developers to express the granularity at which threads are communicating, enabling the expression of richer, more efficient parallel decompositions. Cooperative launch APIs support synchronization amongst thread blocks for the execution of parallel algorithms. Conventional programming models provide a single, simple construct for synchronizing cooperating threads: a barrier across all threads of a thread block (i.e., the syncthreads( ) function). However, programmers would often like to define groups of threads at smaller than thread block granularities and synchronize within the defined groups to enable greater performance, design flexibility, and software reuse in the form of collective group-wide function interfaces.

Cooperative Groups enables programmers to define groups of threads explicitly at sub-block (i.e., as small as a single thread) and multi-block granularities, and to perform collective operations such as synchronization on the threads in a cooperative group. The programming model supports clean composition across software boundaries, so that libraries and utility functions can synchronize safely within their local context without having to make assumptions about convergence. Cooperative Groups primitives enable new patterns of cooperative parallelism, including producer-consumer parallelism, opportunistic parallelism, and global synchronization across an entire grid of thread blocks.

A dispatch unit 415 is configured to transmit instructions to one or more of the functional units. In the embodiment, the scheduler unit 410(K) includes two dispatch units 415 that enable two different instructions from the same warp to be dispatched during each clock cycle. In alternative embodiments, each scheduler unit 410(K) may include a single dispatch unit 415 or additional dispatch units 415.

Each SM 340 includes a register file 420 that provides a set of registers for the functional units of the SM 340. In an embodiment, the register file 420 is divided between each of the functional units such that each functional unit is allocated a dedicated portion of the register file 420. In another embodiment, the register file 420 is divided between the different warps being executed by the SM 340. The register file 420 provides temporary storage for operands connected to the data paths of the functional units.

Each SM 340 comprises L processing cores 450. In an embodiment, the SM 340 includes a large number (e.g., 128, etc.) of distinct processing cores 450. Each core 450 may include a fully-pipelined, single-precision, double-precision, and/or mixed precision processing unit that includes a floating point arithmetic logic unit and an integer arithmetic logic unit. In an embodiment, the floating point arithmetic logic units implement the IEEE 754-2008 standard for floating point arithmetic. In an embodiment, the cores 450 include 64 single-precision (32-bit) floating point cores, 64 integer cores, 32 double-precision (64-bit) floating point cores, and 8 tensor cores.

Tensor cores configured to perform matrix operations, and, in an embodiment, one or more tensor cores are included in the cores 450. In particular, the tensor cores are configured to perform deep learning matrix arithmetic, such as convolution operations for neural network training and inferencing. In an embodiment, each tensor core operates on a 4×4 matrix and performs a matrix multiply and accumulate operation D=A×B+C, where A, B, C, and D are 4×4 matrices.

In an embodiment, the matrix multiply inputs A and B are 16-bit floating point matrices, while the accumulation matrices C and D may be 16-bit floating point or 32-bit floating point matrices. Tensor Cores operate on 16-bit floating point input data with 32-bit floating point accumulation. The 16-bit floating point multiply requires 64 operations and results in a full precision product that is then accumulated using 32-bit floating point addition with the other intermediate products for a 4×4×4 matrix multiply. In practice, Tensor Cores are used to perform much larger two-dimensional or higher dimensional matrix operations, built up from these smaller elements. An API, such as CUDA 9 C++ API, exposes specialized matrix load, matrix multiply and accumulate, and matrix store operations to efficiently use Tensor Cores from a CUDA-C++ program. At the CUDA level, the warp-level interface assumes 16×16 size matrices spanning all 32 threads of the warp.

Each SM 340 also comprises M SFUs 452 that perform special functions (e.g., attribute evaluation, reciprocal square root, and the like). In an embodiment, the SFUs 452 may include a tree traversal unit configured to traverse a hierarchical tree data structure. In an embodiment, the SFUs 452 may include texture unit configured to perform texture map filtering operations. In an embodiment, the texture units are configured to load texture maps (e.g., a 2D array of texels) from the memory 204 and sample the texture maps to produce sampled texture values for use in shader programs executed by the SM 340. In an embodiment, the texture maps are stored in the shared memory/L1 cache 370. The texture units implement texture operations such as filtering operations using mip-maps (i.e., texture maps of varying levels of detail). In an embodiment, each SM 240 includes two texture units.

Each SM 340 also comprises N LSUs 454 that implement load and store operations between the shared memory/L1 cache 470 and the register file 420. Each SM 340 includes an interconnect network 480 that connects each of the functional units to the register file 420 and the LSU 454 to the register file 420, shared memory/L1 cache 470. In an embodiment, the interconnect network 480 is a crossbar that can be configured to connect any of the functional units to any of the registers in the register file 420 and connect the LSUs 454 to the register file and memory locations in shared memory/L1 cache 470.

The shared memory/L1 cache 470 is an array of on-chip memory that allows for data storage and communication between the SM 340 and the primitive engine 335 and between threads in the SM 340. In an embodiment, the shared memory/L1 cache 470 comprises 128 KB of storage capacity and is in the path from the SM 340 to the partition unit 280. The shared memory/L1 cache 470 can be used to cache reads and writes. One or more of the shared memory/L1 cache 470, L2 cache 360, and memory 204 are backing stores.

Combining data cache and shared memory functionality into a single memory block provides the best overall performance for both types of memory accesses. The capacity is usable as a cache by programs that do not use shared memory. For example, if shared memory is configured to use half of the capacity, texture and load/store operations can use the remaining capacity. Integration within the shared memory/L1 cache 470 enables the shared memory/L1 cache 470 to function as a high-throughput conduit for streaming data while simultaneously providing high-bandwidth and low-latency access to frequently reused data.

When configured for general purpose parallel computation, a simpler configuration can be used compared with graphics processing. Specifically, the fixed function graphics processing units shown in FIG. 2, are bypassed, creating a much simpler programming model. In the general purpose parallel computation configuration, the work distribution unit 225 assigns and distributes blocks of threads directly to the DPCs 320. The threads in a block execute the same program, using a unique thread ID in the calculation to ensure each thread generates unique results, using the SM 340 to execute the program and perform calculations, shared memory/L1 cache 470 to communicate between threads, and the LSU 454 to read and write global memory through the shared memory/L1 cache 470 and the memory partition unit 280. When configured for general purpose parallel computation, the SM 340 can also write commands that the scheduler unit 220 can use to launch new work on the DPCs 320.

The PPU 200 may be included in a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, and the like. In an embodiment, the PPU 200 is embodied on a single semiconductor substrate. In another embodiment, the PPU 200 is included in a system-on-a-chip (SoC) along with one or more other devices such as additional PPUs 200, the memory 204, a reduced instruction set computer (RISC) CPU, a memory management unit (MMU), a digital-to-analog converter (DAC), and the like.

In an embodiment, the PPU 200 may be included on a graphics card that includes one or more memory devices 204. The graphics card may be configured to interface with a PCIe slot on a motherboard of a desktop computer. In yet another embodiment, the PPU 200 may be an integrated graphics processing unit (iGPU) or parallel processor included in the chipset of the motherboard.

### Exemplary Computing System

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

FIG. 4B is a conceptual diagram of a processing system 400 implemented using the PPU 200 of FIG. 2, in accordance with an embodiment. The exemplary system 465 may be configured to implement the method 100 shown in FIG. 1. The processing system 400 includes a CPU 430, switch 410, and multiple PPUs 200 each and respective memories 204. The NVLink 210 provides high-speed communication links between each of the PPUs 200. Although a particular number of NVLink 210 and interconnect 202 connections are illustrated in FIG. 4B, the number of connections to each PPU 200 and the CPU 430 may vary. The switch 410 interfaces between the interconnect 202 and the CPU 430. The PPUs 200, memories 204, and NVLinks 210 may be situated on a single semiconductor platform to form a parallel processing module 425. In an embodiment, the switch 410 supports two or more protocols to interface between various different connections and/or links.

In another embodiment (not shown), the NVLink 210 provides one or more high-speed communication links between each of the PPUs 200 and the CPU 430 and the switch 410 interfaces between the interconnect 202 and each of the PPUs 200. The PPUs 200, memories 204, and interconnect 202 may be situated on a single semiconductor platform to form a parallel processing module 425. In yet another embodiment (not shown), the interconnect 202 provides one or more communication links between each of the PPUs 200 and the CPU 430 and the switch 410 interfaces between each of the PPUs 200 using the NVLink 210 to provide one or more high-speed communication links between the PPUs 200. In another embodiment (not shown), the NVLink 210 provides one or more high-speed communication links between the PPUs 200 and the CPU 430 through the switch 410. In yet another embodiment (not shown), the interconnect 202 provides one or more communication links between each of the PPUs 200 directly. One or more of the NVLink 210 high-speed communication links may be implemented as a physical NVLink interconnect or either an on-chip or on-die interconnect using the same protocol as the NVLink 210.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 425 may be implemented as a circuit board substrate and each of the PPUs 200 and/or memories 204 may be packaged devices. In an embodiment, the CPU 430, switch 410, and the parallel processing module 425 are situated on a single semiconductor platform.

In an embodiment, the signaling rate of each NVLink 210 is 20 to 25 Gigabits/second and each PPU 200 includes six NVLink 210 interfaces (as shown in FIG. 4B, five NVLink 210 interfaces are included for each PPU 200). Each NVLink 210 provides a data transfer rate of 25 Gigabytes/second in each direction, with six links providing 300 Gigabytes/second. The NVLinks 210 can be used exclusively for PPU-to-PPU communication as shown in FIG. 4B, or some combination of PPU-to-PPU and PPU-to-CPU, when the CPU 430 also includes one or more NVLink 210 interfaces.

In an embodiment, the NVLink 210 allows direct load/store/atomic access from the CPU 430 to each PPU's 200 memory 204. In an embodiment, the NVLink 210 supports coherency operations, allowing data read from the memories 204 to be stored in the cache hierarchy of the CPU 430, reducing cache access latency for the CPU 430. In an embodiment, the NVLink 210 includes support for Address Translation Services (ATS), allowing the PPU 200 to directly access page tables within the CPU 430. One or more of the NVLinks 210 may also be configured to operate in a low-power mode.

FIG. 4C illustrates an exemplary system 465 in which the various architecture and/or functionality of the various previous embodiments may be implemented. The exemplary system 465 may be configured to implement the method 100 shown in FIG. 1.

As shown, a system 465 is provided including at least one central processing unit 430 that is connected to a communication bus 475. The communication bus 475 may be implemented using any suitable protocol, such as PCI (Peripheral Component Interconnect), PCI-Express, AGP (Accelerated Graphics Port), HyperTransport, or any other bus or point-to-point communication protocol(s). The system 465 also includes a main memory 440. Control logic (software) and data are stored in the main memory 440 which may take the form of random access memory (RAM).

The system 465 also includes input devices 460, the parallel processing system 425, and display devices 445, i.e. a conventional CRT (cathode ray tube), LCD (liquid crystal display), LED (light emitting diode), plasma display or the like. User input may be received from the input devices 460, e.g., keyboard, mouse, touchpad, microphone, and the like. Each of the foregoing modules and/or devices may even be situated on a single semiconductor platform to form the system 465. Alternately, the various modules may also be situated separately or in various combinations of semiconductor platforms per the desires of the user.

Further, the system 465 may be coupled to a network (e.g., a telecommunications network, local area network (LAN), wireless network, wide area network (WAN) such as the Internet, peer-to-peer network, cable network, or the like) through a network interface 435 for communication purposes.

The system 465 may also include a secondary storage (not shown). The secondary storage includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner.

Computer programs, or computer control logic algorithms, may be stored in the main memory 440 and/or the secondary storage. Such computer programs, when executed, enable the system 465 to perform various functions. The memory 440, the storage, and/or any other storage are possible examples of computer-readable media.

The architecture and/or functionality of the various previous figures may be implemented in the context of a general computer system, a circuit board system, a game console system dedicated for entertainment purposes, an application-specific system, and/or any other desired system. For example, the system 465 may take the form of a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, a mobile phone device, a television, workstation, game consoles, embedded system, and/or any other type of logic.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

### Graphics Processing Pipeline

In an embodiment, the PPU 200 comprises a graphics processing unit (GPU). The PPU 200 is configured to receive commands that specify shader programs for processing graphics data. Graphics data may be defined as a set of primitives such as points, lines, triangles, quads, triangle strips, and the like. Typically, a primitive includes data that specifies a number of vertices for the primitive (e.g., in a model-space coordinate system) as well as attributes associated with each vertex of the primitive. The PPU 200 can be configured to process the graphics primitives to generate a frame buffer (i.e., pixel data for each of the pixels of the display).

An application writes model data for a scene (i.e., a collection of vertices and attributes) to a memory such as a system memory or memory 204. The model data defines each of the objects that may be visible on a display. The application then makes an API call to the driver kernel that requests the model data to be rendered and displayed. The driver kernel reads the model data and writes commands to the one or more streams to perform operations to process the model data. The commands may reference different shader programs to be implemented on the SMs 340 of the PPU 200 including one or more of a vertex shader, hull shader, domain shader, geometry shader, and a pixel shader. For example, one or more of the SMs 340 may be configured to execute a vertex shader program that processes a number of vertices defined by the model data. In an embodiment, the different SMs 340 may be configured to execute different shader programs concurrently. For example, a first subset of SMs 340 may be configured to execute a vertex shader program while a second subset of SMs 340 may be configured to execute a pixel shader program. The first subset of SMs 340 processes vertex data to produce processed vertex data and writes the processed vertex data to the L2 cache 360 and/or the memory 204. After the processed vertex data is rasterized (i.e., transformed from three-dimensional data into two-dimensional data in screen space) to produce fragment data, the second subset of SMs 340 executes a pixel shader to produce processed fragment data, which is then blended with other processed fragment data and written to the frame buffer in memory 204. The vertex shader program and pixel shader program may execute concurrently, processing different data from the same scene in a pipelined fashion until all of the model data for the scene has been rendered to the frame buffer. Then, the contents of the frame buffer are transmitted to a display controller for display on a display device.

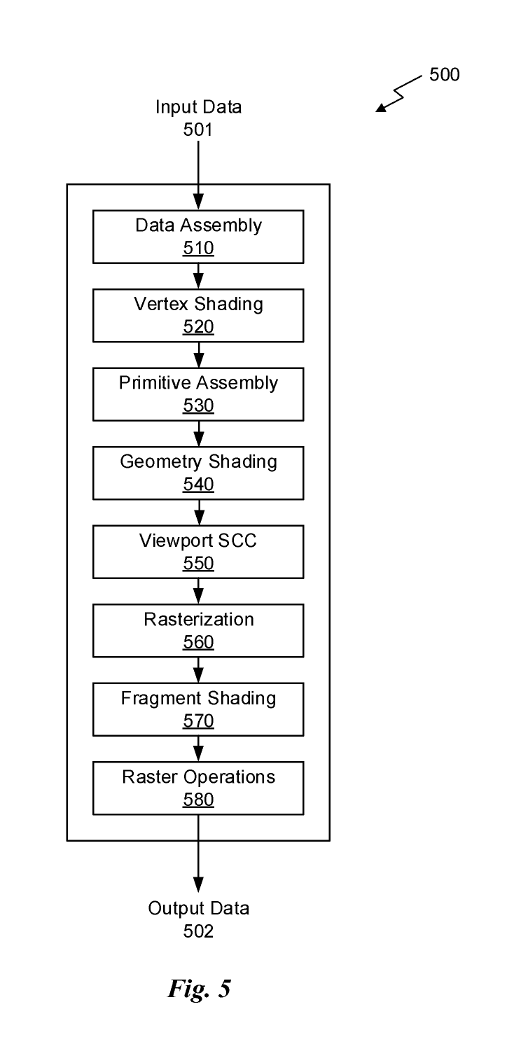

FIG. 5 is a conceptual diagram of a graphics processing pipeline 500 implemented by the PPU 200 of FIG. 2, in accordance with an embodiment. The graphics processing pipeline 500 is an abstract flow diagram of the processing steps implemented to generate 2D computer-generated images from 3D geometry data. As is well-known, pipeline architectures may perform long latency operations more efficiently by splitting up the operation into a plurality of stages, where the output of each stage is coupled to the input of the next successive stage. Thus, the graphics processing pipeline 500 receives input data 501 that is transmitted from one stage to the next stage of the graphics processing pipeline 500 to generate output data 502. In an embodiment, the graphics processing pipeline 500 may represent a graphics processing pipeline defined by the OpenGL® API. As an option, the graphics processing pipeline 500 may be implemented in the context of the functionality and architecture of the previous Figures and/or any subsequent Figure(s).

As shown in FIG. 5, the graphics processing pipeline 500 comprises a pipeline architecture that includes a number of stages. The stages include, but are not limited to, a data assembly stage 510, a vertex shading stage 520, a primitive assembly stage 530, a geometry shading stage 540, a viewport scale, cull, and clip (VSCC) stage 550, a rasterization stage 560, a fragment shading stage 570, and a raster operations stage 580. In an embodiment, the input data 501 comprises commands that configure the processing units to implement the stages of the graphics processing pipeline 500 and geometric primitives (e.g., points, lines, triangles, quads, triangle strips or fans, etc.) to be processed by the stages. The output data 502 may comprise pixel data (i.e., color data) that is copied into a frame buffer or other type of surface data structure in a memory.

The data assembly stage 510 receives the input data 501 that specifies vertex data for high-order surfaces, primitives, or the like. The data assembly stage 510 collects the vertex data in a temporary storage or queue, such as by receiving a command from the host processor that includes a pointer to a buffer in memory and reading the vertex data from the buffer. The vertex data is then transmitted to the vertex shading stage 520 for processing.

The vertex shading stage 520 processes vertex data by performing a set of operations (i.e., a vertex shader or a program) once for each of the vertices. Vertices may be, e.g., specified as a 4-coordinate vector (i.e., <x, y, z, w>) associated with one or more vertex attributes (e.g., color, texture coordinates, surface normal, etc.). The vertex shading stage 520 may manipulate individual vertex attributes such as position, color, texture coordinates, and the like. In other words, the vertex shading stage 520 performs operations on the vertex coordinates or other vertex attributes associated with a vertex. Such operations commonly including lighting operations (i.e., modifying color attributes for a vertex) and transformation operations (i.e., modifying the coordinate space for a vertex). For example, vertices may be specified using coordinates in an object-coordinate space, which are transformed by multiplying the coordinates by a matrix that translates the coordinates from the object-coordinate space into a world space or a normalized-device-coordinate (NCD) space. The vertex shading stage 520 generates transformed vertex data that is transmitted to the primitive assembly stage 530.

The primitive assembly stage 530 collects vertices output by the vertex shading stage 520 and groups the vertices into geometric primitives for processing by the geometry shading stage 540. For example, the primitive assembly stage 530 may be configured to group every three consecutive vertices as a geometric primitive (i.e., a triangle) for transmission to the geometry shading stage 540. In some embodiments, specific vertices may be reused for consecutive geometric primitives (e.g., two consecutive triangles in a triangle strip may share two vertices). The primitive assembly stage 530 transmits geometric primitives (i.e., a collection of associated vertices) to the geometry shading stage 540.

The geometry shading stage 540 processes geometric primitives by performing a set of operations (i.e., a geometry shader or program) on the geometric primitives. Tessellation operations may generate one or more geometric primitives from each geometric primitive. In other words, the geometry shading stage 540 may subdivide each geometric primitive into a finer mesh of two or more geometric primitives for processing by the rest of the graphics processing pipeline 500. The geometry shading stage 540 transmits geometric primitives to the viewport SCC stage 550.

In an embodiment, the graphics processing pipeline 500 may operate within a streaming multiprocessor and the vertex shading stage 520, the primitive assembly stage 530, the geometry shading stage 540, the fragment shading stage 570, and/or hardware/software associated therewith, may sequentially perform processing operations. Once the sequential processing operations are complete, in an embodiment, the viewport SCC stage 550 may utilize the data. In an embodiment, primitive data processed by one or more of the stages in the graphics processing pipeline 500 may be written to a cache (e.g. L1 cache, a vertex cache, etc.). In this case, in an embodiment, the viewport SCC stage 550 may access the data in the cache. In an embodiment, the viewport SCC stage 550 and the rasterization stage 560 are implemented as fixed function circuitry.

The viewport SCC stage 550 performs viewport scaling, culling, and clipping of the geometric primitives. Each surface being rendered to is associated with an abstract camera position. The camera position represents a location of a viewer looking at the scene and defines a viewing frustum that encloses the objects of the scene. The viewing frustum may include a viewing plane, a rear plane, and four clipping planes. Any geometric primitive entirely outside of the viewing frustum may be culled (i.e., discarded) because the geometric primitive will not contribute to the final rendered scene. Any geometric primitive that is partially inside the viewing frustum and partially outside the viewing frustum may be clipped (i.e., transformed into a new geometric primitive that is enclosed within the viewing frustum. Furthermore, geometric primitives may each be scaled based on a depth of the viewing frustum. All potentially visible geometric primitives are then transmitted to the rasterization stage 560.

The rasterization stage 560 converts the 3D geometric primitives into 2D fragments (e.g. capable of being utilized for display, etc.). The rasterization stage 560 may be configured to utilize the vertices of the geometric primitives to setup a set of plane equations from which various attributes can be interpolated. The rasterization stage 560 may also compute a coverage mask for a plurality of pixels that indicates whether one or more sample locations for the pixel intercept the geometric primitive. In an embodiment, z-testing may also be performed to determine if the geometric primitive is occluded by other geometric primitives that have already been rasterized. The rasterization stage 560 generates fragment data (i.e., interpolated vertex attributes associated with a particular sample location for each covered pixel) that are transmitted to the fragment shading stage 570.

The fragment shading stage 570 processes fragment data by performing a set of operations (i.e., a fragment shader or a program) on each of the fragments. The fragment shading stage 570 may generate pixel data (i.e., color values) for the fragment such as by performing lighting operations or sampling texture maps using interpolated texture coordinates for the fragment. The fragment shading stage 570 generates pixel data that is transmitted to the raster operations stage 580.

The raster operations stage 580 may perform various operations on the pixel data such as performing alpha tests, stencil tests, and blending the pixel data with other pixel data corresponding to other fragments associated with the pixel. When the raster operations stage 580 has finished processing the pixel data (i.e., the output data 502), the pixel data may be written to a render target such as a frame buffer, a color buffer, or the like.

It will be appreciated that one or more additional stages may be included in the graphics processing pipeline 500 in addition to or in lieu of one or more of the stages described above. Various implementations of the abstract graphics processing pipeline may implement different stages. Furthermore, one or more of the stages described above may be excluded from the graphics processing pipeline in some embodiments (such as the geometry shading stage 540). Other types of graphics processing pipelines are contemplated as being within the scope of the present disclosure. Furthermore, any of the stages of the graphics processing pipeline 500 may be implemented by one or more dedicated hardware units within a graphics processor such as PPU 200. Other stages of the graphics processing pipeline 500 may be implemented by programmable hardware units such as the SM 340 of the PPU 200.

The graphics processing pipeline 500 may be implemented via an application executed by a host processor, such as a CPU. In an embodiment, a device driver may implement an application programming interface (API) that defines various functions that can be utilized by an application in order to generate graphical data for display. The device driver is a software program that includes a plurality of instructions that control the operation of the PPU 200. The API provides an abstraction for a programmer that lets a programmer utilize specialized graphics hardware, such as the PPU 200, to generate the graphical data without requiring the programmer to utilize the specific instruction set for the PPU 200. The application may include an API call that is routed to the device driver for the PPU 200. The device driver interprets the API call and performs various operations to respond to the API call. In some instances, the device driver may perform operations by executing instructions on the CPU. In other instances, the device driver may perform operations, at least in part, by launching operations on the PPU 200 utilizing an input/output interface between the CPU and the PPU 200. In an embodiment, the device driver is configured to implement the graphics processing pipeline 500 utilizing the hardware of the PPU 200.

Various programs may be executed within the PPU 200 in order to implement the various stages of the graphics processing pipeline 500. For example, the device driver may launch a kernel on the PPU 200 to perform the vertex shading stage 520 on one SM 340 (or multiple SMs 340). The device driver (or the initial kernel executed by the PPU 300) may also launch other kernels on the PPU 300 to perform other stages of the graphics processing pipeline 500, such as the geometry shading stage 540 and the fragment shading stage 570. In addition, some of the stages of the graphics processing pipeline 500 may be implemented on fixed unit hardware such as a rasterizer or a data assembler implemented within the PPU 300. It will be appreciated that results from one kernel may be processed by one or more intervening fixed function hardware units before being processed by a subsequent kernel on an SM 340.

### Machine Learning

Deep neural networks (DNNs) developed on processors, such as the PPU 200 have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron or perceptron is the most basic model of a neural network. In one example, a perceptron may receive one or more inputs that represent various features of an object that the perceptron is being trained to recognize and classify, and each of these features is assigned a certain weight based on the importance of that feature in defining the shape of an object.

A deep neural network (DNN) model includes multiple layers of many connected perceptrons (e.g., nodes) that can be trained with enormous amounts of input data to quickly solve complex problems with high accuracy. In one example, a first layer of the DLL model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions that are supported by the PPU 200. Inferencing is less compute-intensive than training, being a latency-sensitive process where a trained neural network is applied to new inputs it has not seen before to classify images, translate speech, and generally infer new information.

Neural networks rely heavily on matrix math operations, and complex multi-layered networks require tremendous amounts of floating-point performance and bandwidth for both efficiency and speed. With thousands of processing cores, optimized for matrix math operations, and delivering tens to hundreds of TFLOPS of performance, the PPU 200 is a computing platform capable of delivering performance required for deep neural network-based artificial intelligence and machine learning applications.

### A Deep Learning Based Approach for Time Series Data Post-Processing

When using data-driven approaches to character animation, it may be important to label motion capture (‘mocap’) data with phase values to represent the periodic nature of natural motion. This phase information may then be used as part of the process of training neural networks to match existing animations, and then in turn generate new ones.

For the purposes of training a neural network, it may be necessary to label each mocap frame with a phase value. A current approach to label the phases involves semi-automatically labelling the frames in which the right and left foot touches the ground and using that to generate the phase for each frame which are then corrected by human inspection. This approach is time-consuming, since a human labeler is required to actively check whether the foot-contact labels are accurate.

In response, a supervised learning method may automatically solve this phase labeling problem and may also have value in more general post-processing solutions to time series data regression problems.

Previous approaches related to time series data post-processing can be categorized into two different categories: 1) Improving model accuracy by building larger, more complex models so that post processing is not necessary, and 2) Using concepts from signal processing to hand-craft a post-processing step.

Building larger, complex models might be inconvenient when sufficiently accurate results are required in a short time—implementing and training large, complex models might take significant amounts of time. Using concepts from signal processing to hand-craft post processing steps (such as high frequency noise removal) not only require domain knowledge in signal processing, but also might take a long time to implement. Post-processing the results this way might additionally fail to generalize to the entire dataset.

In one embodiment, a strategy may be provided to perform accurate time series regression. This strategy takes advantage of the observation that most models that are used in time series regression tasks make systematic, discernible errors, and that it is possible to train a neural network that identifies these errors and corrects them.

In one embodiment, an already known model may be selected to perform time series regression. There is no limitation on what type of model can be chosen—options include simple linear regression, feed-forward neural networks, CNNs for grid-like input data, LSTMs or RNNs, or any model suitable for time-series regression. In one embodiment, a one-dimensional (1D) convolutional neural network is trained to map the output of the first step to the correct labels. This step may learn a series of filters to detect/correct/post-process the previous predictions, which in effect learns systematic errors in the predictions of the first step and corrects it.

In this way, the error-correcting method may allow for the rapid building of sufficiently accurate time series regression models with simple models. In one embodiment, it is possible to train a simple feed-forward neural network as the first step, and correct its mistakes in the second step as opposed to trying to do all with a well-trained LSTM model, which may be difficult to train. This strategy also allows for working on imperfectly trained models in the first step, since the error the first step introduces will be reduced in the second step.

Additionally, the above method consistently denoises outputs, which may be important for applications requiring temporal consistency. Further, some of the error correction may extend beyond denoising. For example, the network may be able to catch and correct systematic mistakes.

### Phase Labeler

In one embodiment, the phase labeler may include 2 stages: a prediction stage and a post-processing stage. In one embodiment, the prediction stage may consist of a simple feedforward network that is trained to map character states (joint positions and velocities) to character phase. In one embodiment, the weights of this network may be learned through a simple supervised learning pipeline. In one embodiment, this operation may be applied to each frame individually, hence the outputs are not generated using any temporal pattern in the mocap data.

In one embodiment, the post-processing stage may involve training a 1D convolutional neural network (convolution over time/frames, i.e. temporal convolution) that learns to detect the systematic errors that the first network makes and correct them. In this way, a data-driven approach may be used to perform fully automated mocap phase detection.

In one embodiment, this approach may be applied to a very broad set of problems involving time series regression.

### Post-Processing

Mistakes time series regression models make may have a discernable structure, especially on a time axis. In order to learn this structure and fix it, in one embodiment, a 1D convolutional neural network (the convolution operation on time axis, i.e. temporal convolution) may be taught that maps the predictions made by previous time series models to the correct values. In one embodiment, this may include: 1) Using a 1D convolutional neural network to learn and correct structured errors in time series predictions, and 2) improving the overall accuracy of the model not by building more complex and hard-to-train models, but by adding a second deep learning based post-processing step that makes both the prediction stage and the post-processing stage simple, easy to implement and train.

### Exemplary Problem Definition

In one embodiment, the proposed method can be quantitatively explained as follows:
Off-line time series regression: “Given a time series of vector inputs {x_{0:t}} and scalar labels {y_{0:t}}, find a function f which takes in all {x_{0:t}} and estimates all {y_{0:t}}˜f({x_{0:t}})”.

### Exemplary Methodology

In one embodiment, one exemplary method consists of 2 steps:

1. Regression Step: This step serves as a way to get generate initial predictions given time series inputs, and involves training any suitable time series model to map the inputs to outputs. Since the second error-correcting step will function as a way to correct systematic errors introduced by the first step, the model chosen here can be very simple, and without any time dependency. For example, the model chosen here can be a simple neural network that maps each xₜ to yₜ with a simple feed-forward neural network, without considering any time-dependency.

2. Error-Correction Step: This step takes in all the predictions made by the first step, {ŷ_{0:t}} and trains a 1D convolutional neural network that maps these predictions to the actual labels.

In one embodiment, the initial step generates the first predictions on the labels, and the second step takes all the predictions that the first step has made over time, and passes it through a convolutional network that learns how to correct the systematic errors that the first network has made, and makes a second, more refined set of predictions on the labels.

### Exemplary Benefits

In one embodiment, unlike a semi-automatic phase labelling methodology, the current method may not require human involvement for accurate results. Semi-automatic phase labelling uses an automated system that detects when the character foot joint velocities fall below a certain threshold, and recommends these points as candidate foot contact frames. Since this approach is not very accurate, a human labeler is needed to go over these frames and decide whether these frames actually do correspond to foot contact points.

After that, the phases 0 and 180 degrees are assigned to right and left foot contact frames respectively, and all the intermediate values are interpolated linearly. Other potential attempts to automate the phase labelling process by hard-coding a more sophisticated selection process (for example, adding other conditions on foot joint velocities) might not generalize well on a broad range of mocap data. Utilizing a learning-based approach provides a fully automated phase labelling system that may generalize over a broad range of mocap data if it is trained with a dataset that captures different types of mocap data.

In one embodiment, the disclosed post-processing methodology has its own advantages over other standard time series regression postprocessing methodologies, as listed below.

Full Automation: Once the phase labeler is trained on existing phase-labelled mocap data, it is fully automated and does not require human intervention.

Learning-Based Approach: The disclosed approach is entirely learning based—no domain knowledge is required in post-processing, signal processing or time series regression, and no domain specific knowledge is required in the particular problem being solved.

Robustness: Both the initial time series regression model, and the post-processing convolutional neural network have a combined result that satisfies accuracy constraints. In this way, the models in both the two stages may be imperfect and still produce a desired result.

Rapid Prototyping: The 1D convolutional neural network for post-processing may be implemented using standard neural network libraries. Training these models is straightforward compared to more complex methods. Instead of training a single, complex model with high accuracy, a simple, low accuracy model may be trained, and the errors it makes may be corrected with the described 1D convolution, which is also easy and very fast to train.

Large Temporal Component: If the filter sizes of the convolutional neural network are large enough, error patterns may be captured that span over a large number of time points. Since most time series regression models either have short term memory, or make the Markov assumption (next step is only determined by the previous state), this may help with model accuracy. Models with longer memory (i.e. Long Short Term Memory (LSTM) Networks) may be difficult to train, and may require large amounts of data. Since the second step of the proposed strategy can contain very large time windows (as in convolutional kernels), it is possible to build models that can identify and incorporate patterns that cover very large time windows, very efficiently.

As described above, it can often be important to have mocap data with phase values labeled in order to train learning-based models that utilize this parameter. In one embodiment, an accurate, automated phase labeler may be used to generate training data for Phase Functioned Neural Nets (PFNN), which have the potential to power the character animations in game engines or animation software. Specifically, walking/running/jogging animations may be generated with PFNNs, which may be trained using motion capture clips whose phase labels are generated by the disclosed model. For PFNN phase detection, example inputs may include a character state at each frame, and example outputs may include a phase of the motion cycle the character is in at each time point.

In addition, post processing time series regression models are a general problem that may be applied on a large number of problems and products. In one embodiment, the invention described herein may be applied to all time series regression tasks. The following are examples of tasks on which this invention may be applied:

Object Tracking: We might want to determine an object's 3D position using sensory information, such as vision, ultrasonic sensors, etc. In one embodiment, the post-processing approach may be used to reduce the error and noise introduced by another model that primarily deals with object localization. For example, we might want to predict the position of a car given previous observations of that car. In one embodiment, the post processing approach may act as a filter that combines past predictions about the car's location to refine a current prediction about where the car is. For car speed detection, exemplary inputs may include a video feed obtained from a webcam attached on the front of the car, and exemplary outputs may include an indication of how fast the car is going.

Robotic Sensor Denoising: Robotic sensor measurements are inherently noisy. In most traditional approaches, it is assumed that sensor noise is independent of the robot state and the value that is being measured, and the “noise random variable” has a fixed probability distribution. In one embodiment, in order to operate in settings in which these assumptions are not valid, a two-step model may be designed that performs denoising on the measurements. The first prediction step may take the robot state and the value that is currently read by the sensor, and my output an estimate on what the true measurement should be (akin to predicting the phase from the character state).

In one embodiment, the second post-processing step may take in several outputs of the prediction step (e.g., a current output and one or more predictions), and may apply a 1D temporal convolutional network on those outputs to predict the post-processed sensor measurement. In one example (sensing power generation for a solar car), exemplary inputs may include relevant environmental factors, such as temperature, position of sun in the sky, etc., and exemplary outputs may include an indication of how much power the solar panel is generating.

Video Super-Resolution: In one embodiment, the 1D convolution post-processing approach may also be applied to the removal of temporal flicker in video super resolution work by trying to identify and correct the systematic mistakes of ‘per-frame’ super resolution models. This approach may also help deal with large input dimensions with time series data (for example, if the input to the model is a video). In one embodiment, if each feature vector at time t is D-dimensional, feeding in T time steps of input feature vectors to a single model amounts to a T*D input feature. By decomposing the problem over two stages, the required memory footprint may be reduced. For instance, the first stage may be fed feature D, and the second stage may be fed feature T.

Object Localization: In one embodiment, exemplary inputs may include an ultrasonic range map ‘video,’ and exemplary outputs may include an x-y location of an object of interest.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method comprising:
identifying predicted labels for a plurality of time-associated data points;
training a convolutional neural network (CNN), utilizing the predicted labels for the plurality of time-associated data points as well as ground truth labels for the plurality of time-associated data points, to create a trained CNN; and
performing error correction, utilizing the trained CNN.

2. The method of claim 1, wherein the predicted labels are created utilizing time-series regression.

3. The method of claim 1, wherein the ground truth labels for the plurality of time-associated data points include labels for the time-associated data points that have been verified as correct.

4. The method of claim 1, wherein the CNN includes a one-dimensional (1D) convolutional neural network.

5. The method of claim 1, wherein the CNN is trained to map the predicted labels for the plurality of time-associated data points to the ground truth labels for the plurality of time-associated data points.

6. The method of claim 1, wherein performing the error correction includes inputting another plurality of time-associated data points, and predicted labels for the other plurality of time-associated data points, into the trained CNN.

7. The method of claim 6, wherein performing the error correction includes creating and returning error-corrected labels for the other plurality of time-associated data points, based on the predicted labels for the other plurality of time-associated data points, utilizing the trained CNN.

8. The method of claim 7, wherein the other plurality of time-associated data points, and the error-corrected labels for the other plurality of time-associated data points, are used to train another neural network.

9. The method of claim 1, wherein the plurality of time-associated data points include motion capture (mocap) data.

10. The method of claim 9, wherein the predicted labels include a phase value for each instance of the mocap data.

11. A system comprising:
a processor that is configured to:
identify predicted labels for a plurality of time-associated data points;
train a convolutional neural network (CNN), utilizing the predicted labels for the plurality of time-associated data points as well as ground truth labels for the plurality of time-associated data points, to create a trained CNN; and
perform error correction, utilizing the trained CNN.

12. The system of claim 11, wherein the predicted labels are created utilizing time-series regression.

13. The system of claim 11, wherein the ground truth labels for the plurality of time-associated data points include labels for the time-associated data points that have been verified as correct.

14. The system of claim 11, wherein the CNN includes a one-dimensional (1D) convolutional neural network.

15. The system of claim 11, wherein the CNN is trained to map the predicted labels for the plurality of time-associated data points to the ground truth labels for the plurality of time-associated data points.

16. The system of claim 11, wherein performing the error correction includes inputting another plurality of time-associated data points, and predicted labels for the other plurality of time-associated data points, into the trained CNN.

17. The system of claim 16, wherein performing the error correction includes creating and returning error-corrected labels for the other plurality of time-associated data points, based on the predicted labels for the other plurality of time-associated data points, utilizing the trained CNN.

18. The system of claim 17, wherein the other plurality of time-associated data points, and the error-corrected labels for the other plurality of time-associated data points, are used to train another neural network.

19. The system of claim 11, wherein the plurality of time-associated data points include mocap data.

20. A computer-readable storage medium storing instructions that, when executed by a processor, causes the processor to perform steps comprising:
identifying predicted labels for a plurality of time-associated data points;
training a convolutional neural network (CNN), utilizing the predicted labels for the plurality of time-associated data points as well as ground truth labels for the plurality of time-associated data points, to create a trained CNN; and
performing error correction, utilizing the trained CNN.
